(19) United States
(12) Patent Application Publication
(10) Pub. No.: US 2024/0069242 A1
(43) Pub. Date: Feb. 29, 2024

(54) METHOD SYSTEM FOR SHALE LITHOFACIES IDENTIFICATION AND PREDICTION

(71) Applicant: Shandong University of Science and Technology, Qingdao (CN)

(72) Inventors: Renchao YANG, Qingdao (CN); Hainan ZHANG, Qingdao (CN); Junjian ZHANG, Qingdao (CN)

(21) Appl. No.: 17/895,461

(22) Filed: Aug. 25, 2022

(51) Int. Cl. G01V 99/00

(52) U.S. Cl. CPC G01V 99/00

(57) ABSTRACT

Disclosed is a quantitative identification method of standard chart for shale lithofacies prediction, and relates to the field of shale oil and gas exploration and development. On the basis of logging data, the application designs the discrimination standard of shale lithofacies chart, maximizes the utilization of different types of logging curves, extracts characteristic logging curves, and constructs the identification system of typical lithofacies from two angles of absolute value and relative value of logging curves, thus avoiding the waste of original data sources and subjective errors in the identification process, finally realizing the identification of characteristic logging curves of typical shale lithofacies, and being beneficial to the subsequent research on spatial distribution of shale lithofacies facing the regional research area.

### TECHNICAL FIELD

The application relates to the field of shale oil and gas exploration and development, and in particular to the use of statistical methods to process and analyze logging data so as to establish a set of standard chart quantitative identification system for shale lithofacies prediction.

### BACKGROUND

According to the latest statistics, the reserves of shale gas exploitation resources in China are about 3.61×1013 m³, and the technically recoverable reserves account for about 20% of the global total, so China is the country with the richest shale gas resources in the world. Shale gas is stored in organic-rich mud shale formations, and has the characteristics of “self-generating and self-storing”, so the reservoir characteristics are of great significance to shale gas reservoir formation. The key to the study of reservoir characteristics is to identify the lithofacies that is conducive to shale gas development. Except for the marine shale gas resources of the Longmaxi Formation, the exploration of shale gas in the terrestrial and land-sea transition phases has been slow in China. Moreover, the phase change of the terrestrial phase sediments is fast, the heterogeneity is strong, the types of mineral components are diverse, and the pore structure and types are complex. Therefore, in the actual production process, it may quickly identify higher quality hydrocarbon source rocks or reservoirs by carrying out research on shale lithofacies, finely classifying and identifying different lithofacies, and grasping the development characteristics and patterns of the phases as a whole, which may provide a basis for shale gas development.

The identification and classification of shale lithofacies is the basis for further explaining the oil and gas occurrence law of shale. At present, foreign countries mainly use sedimentary structure, rock mineral composition, paleontology and composition characteristics as standards to classify shale lithofacies; domestic scholars mainly classify the shale lithofacies according to mineral composition, organic characteristics, sedimentary structures and paleontological standards, which roughly include four aspects: (1) Lithofacies are classified according to mineral composition and organic content; (2) Lithofacies are classified according to the paleontology and composition characteristics; (3) Lithofacies are classified according to sedimentary structures, mineral composition and organic content; (4) Lithofacies are classified according to the content of quartz and the types of laminae.

Shale lithofacies identification logging data has been widely used in lithofacies identification and evaluation because of its high vertical resolution and good continuity. According to the method, after logging data of various lithofacies are counted, single-parameter logging identification is carried out first, and the characteristics of logging data are compared one by one; then, multi-parameter comparison is made on the basis of single parameter to avoid data waste and time waste. There are two kinds of multi-parameter logging identification in this application, that is, relative value discrimination method and absolute value discrimination method, thus realizing the refined characterization of shale lithofacies.

### SUMMARY

In order to reduce the cost of shale lithofacies identification and prediction and identify lithofacies more accurately and directly, the application provides a method for identifying and predicting shale lithofacies.

The application adopts the following technical scheme.

A standard chart identification system for shale lithofacies identification and prediction, characterized, including the following steps:

Step 1, classification standard of shale lithofacies in the study area: establishing the shale lithofacies classification standard according to the classification method of “mineral composition-organic+rock structure”, meanwhile, counting the contents of clay minerals, calcareous minerals, and felsic minerals, organic content (TOC) and structural development characteristics of existing shale samples; on this basis, classifying and identifying the types of shale lithofacies in the study area.

Step 2, statistics of standard lithofacies logging curves: selecting representative logging curves GR, RD, SP, AC, CNL, CAL, and making statistics on logging curves corresponding to different shales for preliminary analysis.

Step 3, optimizing logging curve parameters: analyzing the differences of logging curve parameters of different shale lithofacies based on the similarity of logging curves, and selecting the logging curve parameters with large differences for follow-up research.

Step 4, quantitative identification of absolute values and relative values of logging curves: selecting the above characteristic parameters and typical representative layers for pairwise combination, testing the identification degree of different lithofacies, and establishing the logging curve absolute value identification chart; meanwhile, comparing the difference of characteristic curve parameters, and analyzing the matching with logging curve, and establishing the logging curve relative value identification chart.

Optionally, Step 4 specifically includes:
Step 4.1, single logging parameter identification method
comparing the similarities of SP, CAL, RD, GR, CNL and AC of each lithofacies based on the statistical method of logging data and finding out the differences, so as to identify the lithofacies.
Step 4.2, multi-parameter relative value identification method
Step 4.2.1, absolute value discrimination method
on the basis of step 4.1, selecting representative characteristic parameters and typical representative layers for pairwise combination, and testing different recognition degrees.
Step 4.2.2, relative value discrimination method
there is still the problem of dimension inconsistency among different logging series when using this method; therefore, processing the sample set data and test set data by normalization method to eliminate the influence of different dimensions; standardizing the dispersion by the normalization method, and mapping the original data to [0, 1]; the conversion function is as follows:

$${X}_{i} = \frac{x i - x min}{x max - x min}$$

where Xᵢ is normalized data; xᵢ is an original data; xₘᵢₙ is a minimum value of the original data; and xₘₐₓ is a maximum value of the original data.
the advantages of this method are as follows: on one hand, effective information is fully utilized to make the established prediction equation more stable; on the other hand, although both the sample set and the test set are from the data of a well, they are normalized respectively, so that the sample set used to establish the prediction equation and the test set used for identification are independent, and to some extent, the problem of “predicting itself” is avoided.

### BRIEF DESCRIPTION OF THE DRAWINGS

FIG. 1 shows a flow chart of lithofacies prediction technology.

FIG. 2 shows a classification scheme of mud shale lithofacies types in the study area (\textcircled{1} Felsic-rich mud shale \textcircled{2} Clayey felsic mud shale \textcircled{3} Calcium-containing felsic mud shale \textcircled{4} Calcium-rich mud shale \textcircled{5} Felsic-containing calcium mud shale \textcircled{6} Clayey calcium mud shale \textcircled{7} Clay-rich mud shale \textcircled{8} Calcium-containing clayey mud shale \textcircled{9} Felsic-containing clayey mud shale);

FIG. 3 shows a dynamic evaluation of logging curve data corresponding to SP;

FIG. 4 shows a dynamic evaluation of logging curve data corresponding to CAL;

FIG. 5 shows a dynamic evaluation of logging curve data corresponding to GR;

FIG. 6 shows a dynamic evaluation of logging curve data corresponding to RD;

FIG. 7 shows a dynamic evaluation of logging curve data corresponding to CNL;

FIG. 8 shows a dynamic evaluation of logging curve data corresponding to AC;

FIG. 9 shows a dynamic evaluation of SP, CAL and RD logging curve data corresponding to the two lithofacies;

FIG. 10 shows a dynamic evaluation of GR, GNL and AC logging curve data corresponding to the two lithofacies;

FIG. 11 shows an absolute value discrimination template of AC logging curve for identifying lithofacies (A, organic-poor/containing clayey felsic mud shale lithofacies; B, organic-rich felsic-containing clayey mud shale lithofacies);

FIG. 12 shows an absolute value discrimination template of RD logging curve used to identify lithofacies (A, organic-poor/containing clayey felsic mud shale lithofacies; B, organic-rich felsic-containing clayey mud shale lithofacies);

FIG. 13 shows an absolute value discrimination template of CAL logging curve used to identify lithofacies (A, organic-poor/containing clayey felsic mud shale lithofacies; B, organic-rich felsic-containing clayey mud shale lithofacies);

FIG. 14 shows an absolute value discrimination template of RD-CN logging curve used to identify lithofacies when CAL-GR<−0.4;

FIG. 15 shows an absolute value discrimination template of SP-AC logging curve used to identify lithofacies when CAL-GR<−0.4;

FIG. 16 shows an absolute value discrimination template of SP-AC logging curve used to identify lithofacies based on RD-CN;

FIG. 17 shows the shale lithofacies and logging curves of Well Yecan-1 (\textcircled{1} Organic-poor blocky clayey felsic mud shale lithofacies; \textcircled{2} Organic-rich layered felsic-containing clayey mud shale lithofacies).

### DETAILED DESCRIPTION OF THE EMBODIMENTS

The embodiment of the present application will be further explained with reference to the following drawings and specific examples:

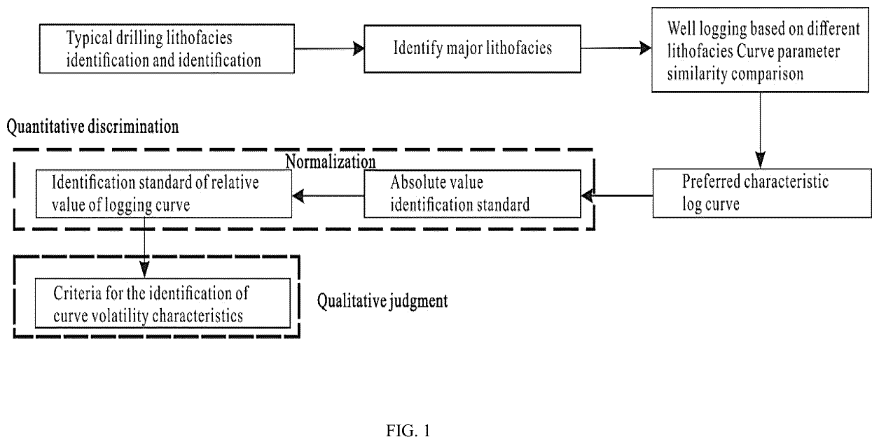

As shown in FIG. 1, in this part, the shale lithofacies identification of Member 2 of Kongdian Formation in Weibei Depression is taken as an example.

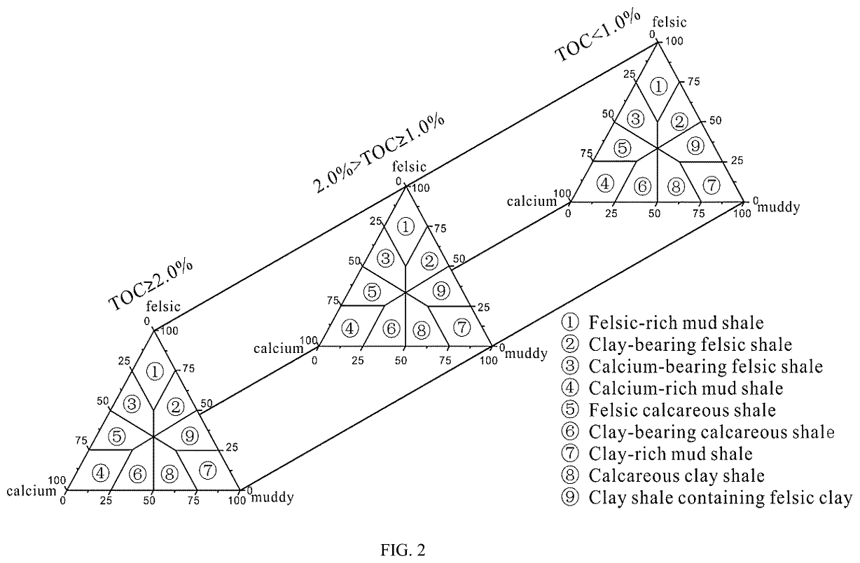

Step 1, according to the lithofacies classification scheme in FIG. 2, six lithofacies are identified in the study area, namely, organic-poor calcium-containing felsic mud shale lithofacies, organic-rich felsic-containing clayey mud shale lithofacies, organic-containing felsic-containing clayey mud shale lithofacies, organic-poor clayey felsic mud shale lithofacies, organic-containing clayey felsic mud shale lithofacies, and organic-rich calcium-rich mud shale lithofacies. Among them, the organic-rich felsic-containing clayey mud shale lithofacies and the organic-poor clayey felsic mud shale lithofacies are the main two lithofacies.

Step 2, statistics of standard lithofacies logging curves: selecting representative logging curves GR, RD, SP, AC, CNL, CAL, and making statistics on logging curves corresponding to different shales for preliminary analysis.

Step 3, optimizing logging curve parameters: analyzing the differences of logging curve parameters of different shale lithofacies based on the similarity of logging curves, and selecting the logging curve parameters with large differences for follow-up research.

Step 4, quantitative identification of absolute values and relative values of logging curves: selecting the above characteristic parameters and typical representative layers for pairwise combination, testing the identification degree of different lithofacies, and establishing the logging curve absolute value identification chart; meanwhile, comparing the difference of characteristic curve parameters, and analyzing the matching with logging curve, and establishing the logging curve relative value identification chart.

Step 4.1: single logging parameter identification method

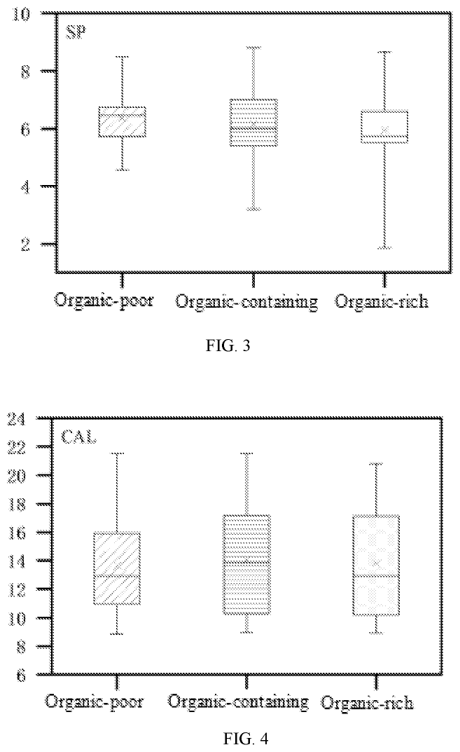

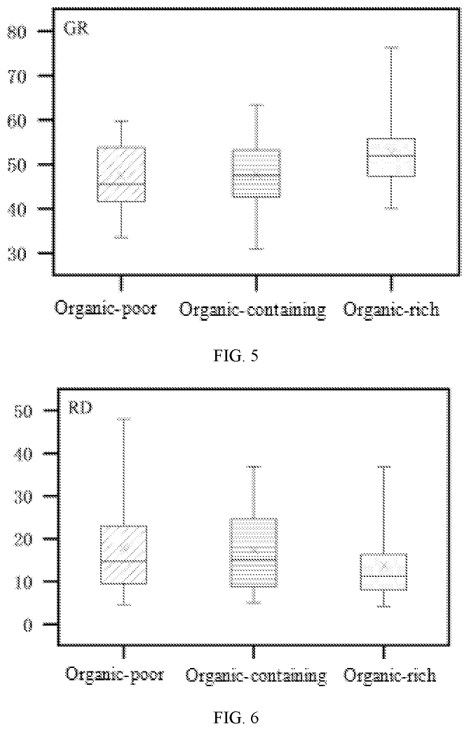

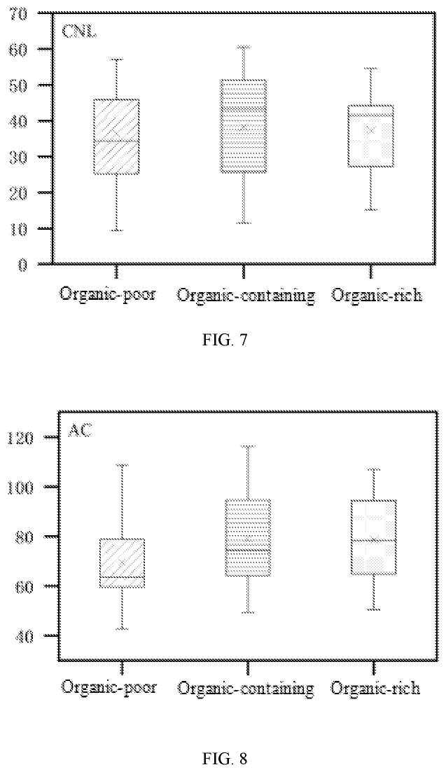

The statistical method based on logging data shows that different types of organic have similarities in logging curves CNL and CAL; however, the logging curve of organic-rich mud shale is characterized by high GR, low RD and low SP. The logging curves of organic-poor mud shale is characterized by low AC characteristics. It also shows that logging curves GR, RD, SP, AC have higher discrimination in identifying rich organic and poor organic, compared with logging curves CNL, CAL (FIG. 3, FIG. 4, FIG. 5, FIG. 6, FIG. 7, FIG. 8).

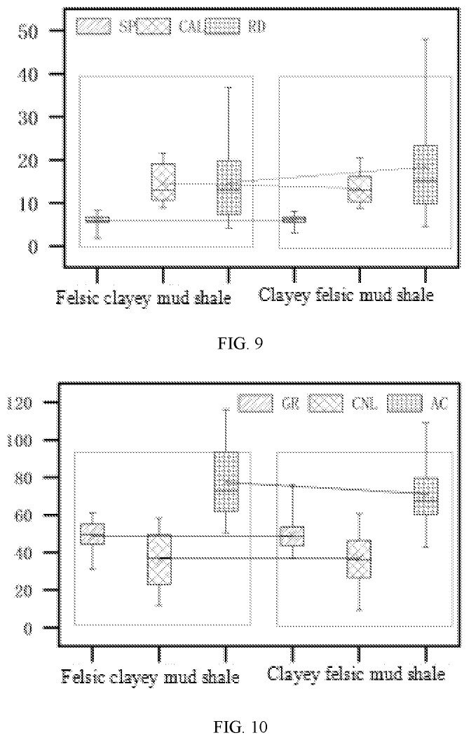

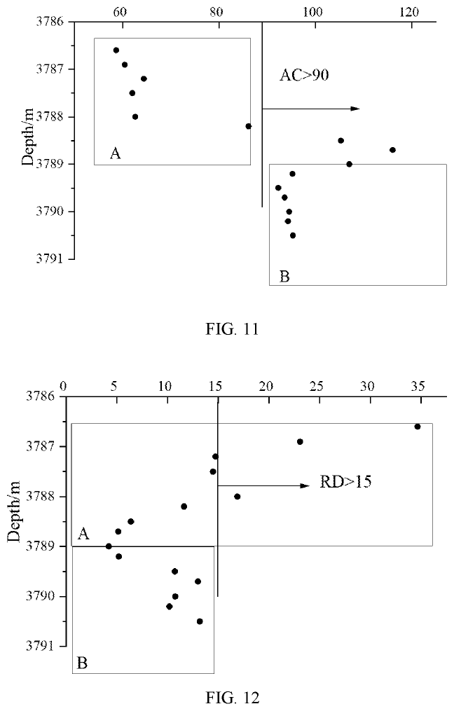

The statistical method based on logging curve data shows that felsic-containing clayey mud shale and clayey felsic mud shale are similar in SP, GR and CNL parameters. However, the felsic-containing clayey mud shale is characterized by “high CAL value and high AC value”, and the clayey felsic mud shale is characterized by “high RD value”. It also shows that logging curves CAL, AC and RD have high sensitivity in identifying different lithofacies (FIG. 9, FIG. 10).

Step 4.2, multi-parameter relative value identification method

Step 4.2.1, absolute value discrimination method

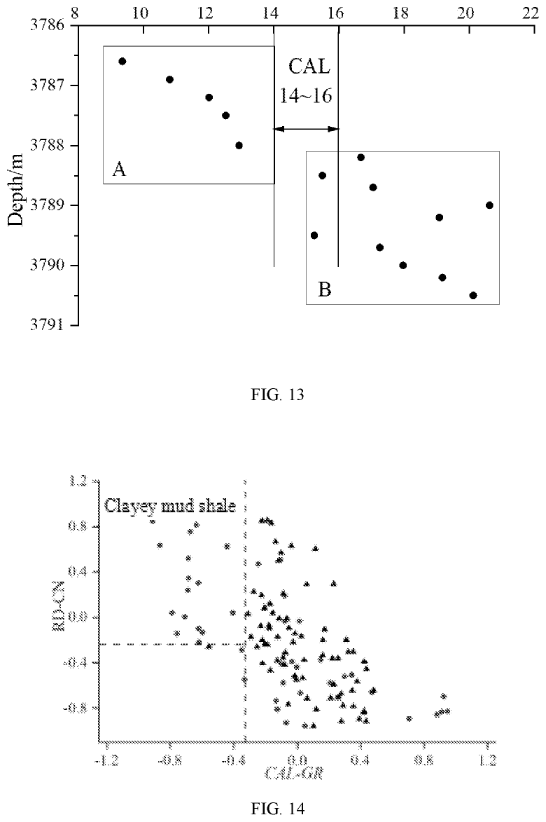

On the basis of step 4.1, selecting representative characteristic parameters and typical representative layers for pairwise combination, and testing different recognition degrees. FIG. 12, FIG. 12, and FIG. 13 show that the quick identification of two lithofacies may be realized by using the following chart. The two critical points are CAL=14-16, RD=15 and AC=90 respectively. The specific classification method is as follows: CAL<14-6 for organic-containing clayey felsic mud shale lithofacies, CAL>14-16 and AC>90 for organic-rich felsic-containing clayey mud shale lithofacies.

Step 4.2.2, relative value discrimination method

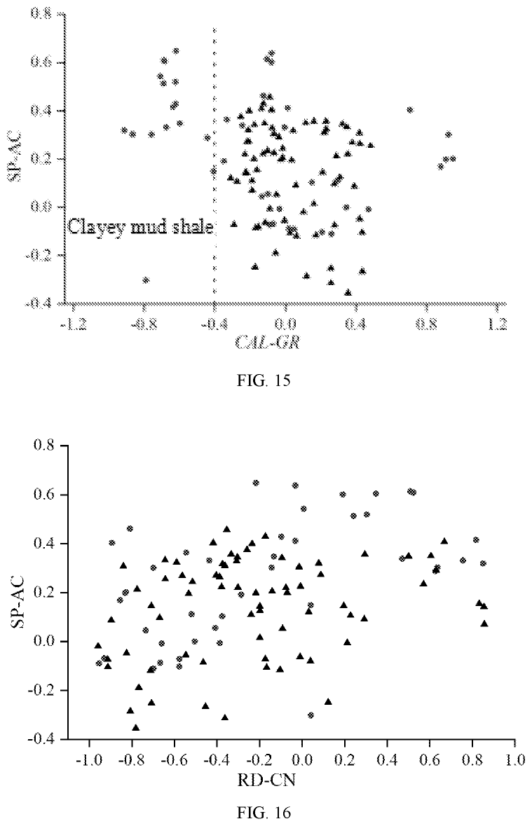

Standardizing the dispersion by the normalization method, and mapping the original data to [0, 1]; the conversion function is as follows:

$${X}_{i} = \frac{x i - x min}{x max - x min}$$

where Xᵢ is normalized data; xᵢ is an original data; xₘᵢₙ is a minimum value of the original data; xₘₐₓ is a maximum value of the original data. The correlation analysis of normalized data shows that this method may not accurately identify different lithologic parameters, but it is worth noting that when CAL-GR<−0.4, clayey mud shale lithofacies may be identified. Therefore, the organic-rich felsic-containing clayey mud shale: CAL-GR<−0.4 (FIG. 14, FIG. 15, FIG. 16).

Step 4.2.3, identification of typical shale lithofacies

\textcircled{1} Organic-Poor Blocky Clayey Felsic Mud Shale Lithofacies

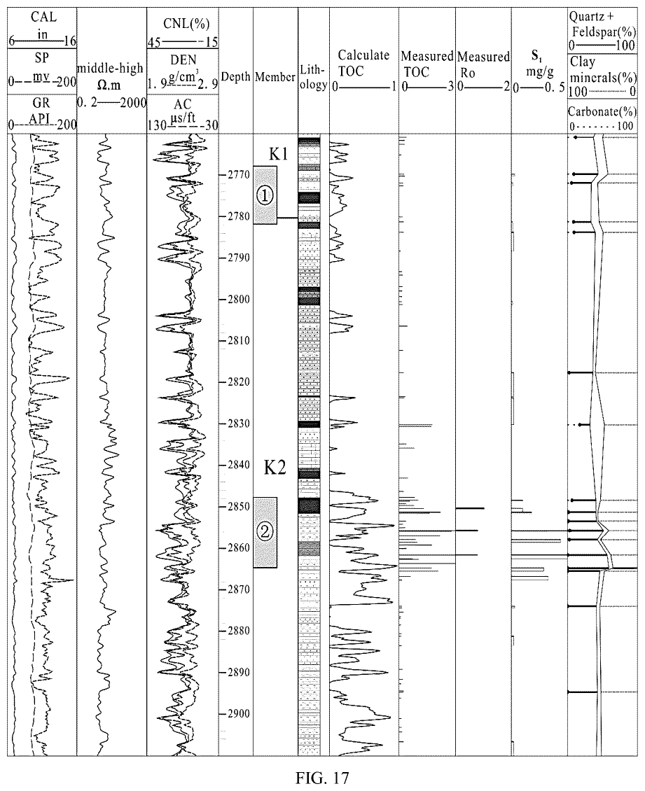

A typical well, Well Yecan-1, is selected to study the identification of the organic-poor massive clayey felsic mud shale lithofacies. According to the rock core photos, this part of the sample is a typical blocky sample, and the logging curve corresponding to this part of the lithofacies conform to that the absolute value of AC is greater than 90, and the amplitude difference of relative values of CAL-GR is less than −0.4, which shows that the above relative value discrimination method has good applicability. Generally speaking, the logging curves of this kind of lithofacies are generally characterized by “low TOC, medium and low AC, medium and high amplitude fluctuation of GR, and medium and high amplitude difference between CAL and GR curves”. (FIG. 17).

\textcircled{2} Organic-Rich Layered Felsic-Containing Clayey Mud Shale Lithofacies

Selecting a section of the typical Well Yecan-1 to study the identification of organic-rich layered felsic-containing clayey mud shale lithofacies. Based on the rock core photos, it may be seen that this part of the samples belongs to typical laminated and layered samples, and the logging curves corresponding to this part of the lithofacies conform to the fact that the absolute value of AC is less than 90, and the amplitude difference of the relative values of CAL-GR is greater than −0.4, which shows that the above relative value discrimination method has good applicability. Generally speaking, the logging curves of this kind of lithofacies are generally characterized by “medium and high TOC, medium and high AC, medium and high amplitude fluctuation of GR, and medium and low amplitude difference between CAL and GR curves” (FIG. 7). The above description is not a limitation of the present application, and the present application is not limited to the above examples. Changes, modifications, additions or substitutions made by those skilled in the technical field within the essential scope of the present application should also belong to the scope of protection of the present application.

1. A standard chart identification system for shale lithofacies identification and prediction, comprising the following steps:
S1, classification standard of shale lithofacies in a study area: establishing a shale lithofacies classification standard according to a classification method of “mineral composition-organic+rock structure”; obtaining contents of clay minerals, calcareous minerals, and felsic minerals, organic content (TOC) and structural development characteristics of existing shale samples; and on this basis, classifying and identifying types of shale lithofacies in the study area, wherein, the shale lithofacies comprise organic-rich felsic-containing clayey mud shale lithofacies and organic-poor clayey felsic mud shale lithofacies;
S2, statistics of standard lithofacies logging curves: selecting representative logging curves GR, RD, SP, AC, CNL, and CAL, wherein, GR represents natural gamma, RD represents deep lateral resistivity, SP represents natural potential, AC represents sound wave, CNL represents compensating electron, CAL represents wellbore diameter; and obtaining statistics on the representative logging curves corresponding to different shale lithofacies for preliminary analysis; and
S3, optimizing logging curve parameters: analyzing differences of the logging curve parameters of the different shale lithofacies based on a similarity of the representative logging curves; and selecting the logging curve parameters with large differences for follow-up research;
S4, quantitative identification of absolute values and relative values of the representative logging curves: selecting the logging curve parameters with large differences and typical representative layers for pairwise combination; testing an identification degree of the different shale lithofacies, establishing a logging curve absolute value identification chart;
comparing a difference of the logging curve parameters with large differences; analyzing a matching with a representative logging curve; and establishing a logging curve relative value identification chart, wherein, a logging curve of organic-rich mud shale is characterized by high GR, low RD and low SP, a logging curve of organic-poor mud shale is characterized by low AC characteristics, wherein the representative logging curves GR, RD, SP, AC have higher discrimination in identifying rich organic and poor organic, compared with the representative logging curves CNL, CAL; wherein CAL<14-16 for the organic-poor clayey felsic mud shale lithofacies, CAL>14-16 and AC>90 for the organic-rich felsic-containing clayey mud shale lithofacies.

2. The standard chart identification system for shale lithofacies identification and prediction according to claim 1, wherein,
S4 specifically comprises:
S4.1, a single logging parameter identification method:
comparing similarities of the representative logging curves SP, CAL, RD, GR, CNL and AC of each shale lithofacies based on a statistical method of logging data and finding out differences, so as to identify the shale lithofacies;
S4.2, a multi-parameter relative value identification method:
S4.2.1, an absolute value discrimination method:
on the basis of step 4.1, selecting the logging curve parameters with large differences and the typical representative layers for the pairwise combination, and testing different identification degrees; and
S4.2.2, a relative value discrimination method:
processing the existing shale samples and test set data by a normalization method to eliminate influence of different dimensions; standardizing a dispersion by the normalization method, and mapping original data to [0, 1]; wherein the normalization method is as follows:
$${X}_{i} = \frac{x i - x min}{x max - x min}$$
wherein Xᵢ is normalized data; Xᵢ is the original data; Xₘᵢₙ is a minimum value of the original data; Xₘₐₓ is a maximum value of the original data.
